(19) United States
(12) Patent Application Publication
(10) Pub. No.: US 2015/0253948 A1
(43) Pub. Date: Sep. 10, 2015

(54) NON-TRANSITORY COMPUTER READABLE MEDIUM STORING AN APPLICATION PROGRAM

(71) Applicant: CANON KABUSHIKI KAISHA, Tokyo (JP)

(72) Inventor: Minoru Kusakabe, Yokohama-shi (JP)

(21) Appl. No.: 14/633,989

(22) Filed: Feb. 27, 2015

(30) Foreign Application Priority Data
Mar. 4, 2014 (JP) 2014-041765
Mar. 4, 2014 (JP) 2014-041766

(51) Int. Cl. G06F 3/0485; G06F 3/0354; G06F 3/038

(52) U.S. Cl. CPC G06F 3/0485; G06F 3/038; G06F 3/03543; G06F 3/03549

(57) ABSTRACT

In an application program that causes a computer to execute steps of: inputting an operation instruction using a plurality of pointing devices; detecting information indicating a used pointing device on the basis of the operation instruction; determining operation content on the basis of an operation instruction from at least one of the plurality of pointing devices; and storing information indicating the pointing device corresponding to the operation content, the operation content is determined in the operation content determining step on the basis of the operation instruction, the information indicating the pointing device detected in the device detecting step, and the information indicating the pointing device stored in the device storing step.

### BACKGROUND OF THE INVENTION

1. Field of the Invention

The present invention relates to an application program, and more particularly to an operation instruction reception method and a method of registering operation instruction reception means in an application program that displays a large image and enlarges an image so as to display a partial image while scrolling the partial image.

2. Description of the Related Art

An operation instruction method for issuing operation instructions such as scroll and magnify efficiently has been disclosed in the related art as a method of displaying a large image or enlarging an image so as to display a partial image while scrolling the partial image.

Japanese Patent Application Laid-open No. 2001-265532, for example, discloses a method of performing a scroll operation efficiently using a right hand mouse and a left hand mouse.
Patent Literature 1: Japanese Patent Application Laid-open No. 2001-265532

### SUMMARY OF THE INVENTION

Pointing devices such as mice are provided by various manufacturers, and typically require a driver that is compatible with an operating system (also referred to as OS hereafter). An application program is notified of an operation instruction from the pointing device via the driver using a general-purpose notification method (a message, for example) provided by the OS. Hence, the application program need only recognize the general-purpose notification mechanism provided by the OS, and therefore the application program can be developed independently of the requirements of device manufacturers. Further, when a user changes a used device, the application program can remain in use without being modified.

Recently, pointing devices are often connected to a PC using a universal serial bus (USB), and a plurality of pointing devices can be connected to a single PC. As described above, however, the pointing devices are not identified by the application program, and therefore general-purpose operation instructions such as cursor movement, click, and double click can be input using any of the pointing devices. In a typical pointing device use method, however, individual devices are not distinguished, and it is therefore difficult to use different functions of the application program depending on the types of pointing devices.

In Japanese Patent Application Laid-open No. 2001-265532, operation instruction content from each device is determined in a controller or a driver of the left hand mouse.

However, although it is possible with Japanese Patent Application Laid-open No. 2001-265532 to perform a scroll operation efficiently, this operation requires the use of a special pointing device or driver. Therefore, the user may be unable to use a preferred pointing device, and when the user changes the pointing device, it may be necessary to modify the application program itself.

Further, particularly when an attempt is made to allocate functions respectively to a plurality of pointing devices, the functions must be set after identifying the respective pointing devices. Devices connected to a PC can typically be identified from driver information. However, when the devices are connected using a USB, as described above, a plurality of identical devices can be connected, and therefore information indicating a USB port must be identified in addition to information indicating the device itself. Here, the information required for identification is not always described in the pointing device itself. Furthermore, the user cannot easily obtain information identifying the plurality of USB ports provided in the PC. It is therefore difficult to allocate functions respectively to a plurality of pointing devices in accordance with user preferences on an application.

Here, Japanese Patent Application Laid-open No. 2001-265532 discloses a method of allocating functions during driver setting. When this method is used, a driver capable of allocating functions must be provided by the device manufacturer, and it may therefore be impossible for the user to allocate a function to a preferred device.

The present invention has been designed in consideration of the problems described above, and an object thereof is to provide an application program with which operation instructions can be input efficiently using a general-purpose pointing device.

The present invention provides a non-transitory computer readable medium storing an application program causing a computer to execute a method comprising steps of:

inputting an operation instruction using a plurality of pointing devices;

detecting information indicating a used pointing device on the basis of the operation instruction;

determining operation content on the basis of the operation instruction from at least one of the plurality of pointing devices; and

storing information indicating the pointing device corresponding to the operation content,

wherein, in the operation content determining step, the operation content is determined on the basis of the operation instruction, the information indicating the pointing device detected in the device detecting step, and the information indicating the pointing device stored in the device storing step.

The present invention also provides a non-transitory computer readable medium storing an application program causing a computer to execute a method comprising steps of:

inputting a general-purpose operation instruction of an operating system as an operation instruction transmitted from a pointing device;

detecting information indicating the used pointing device on the basis of the operation instruction;

determining operation content on the basis of the operation instruction; and

storing information indicating the pointing device corresponding to the operation content,

wherein, in the operation content determining step, the operation content is determined on the basis of the operation instruction, the information indicating the pointing device detected in the device detecting step, and the information indicating the pointing device stored in the device storing step.

The present invention also provides a non-transitory computer readable medium storing an application program causing a computer to execute a method comprising steps of:

inputting an operation instruction using a plurality of pointing devices;

detecting information indicating a used pointing device on the basis of the operation instruction;

determining operation content on the basis of an operation instruction from at least one of the plurality of pointing devices;

storing information indicating the pointing device corresponding to the operation content; and

displaying a registration window for setting the pointing device stored in the device storing step,

wherein, in the registration window displaying step, the registration window is displayed for each operation content in relation to which the information indicating the pointing device is stored,

in the device detecting step, information indicating the pointing device that issues the operation instruction to the registration window is detected, and

in the device storing step, information indicating the pointing device detected in the device detecting step is stored.

According to the present invention, an application program with which operation instructions can be input efficiently using a general-purpose pointing device can be provided.

Further features of the present invention will become apparent from the following description of exemplary embodiments with reference to the attached drawings.

### BRIEF DESCRIPTION OF THE DRAWINGS

FIG. 1 is a view showing a configuration of an apparatus according to the present invention;

FIG. 2 is a view showing a configuration of a computer according to the present invention;

FIGS. 3A and 3B are examples of a screen of an image display application according to the present invention;

FIG. 4 is a view showing a transmission path of an operation instruction according to the present invention;

FIG. 5 is a view showing function blocks according to a first embodiment of the present invention;

FIG. 6 is a flowchart according to the first embodiment of the present invention;

FIGS. 7A and 7B are views showing an example of a method of determining a scroll movement amount, according to the present invention;

FIG. 8 is a view showing another example of a pointing device according to the present invention;

FIG. 9 is a view showing function blocks according to a second embodiment of the present invention;

FIG. 10 is a flowchart according to the second embodiment of the present invention;

FIGS. 11A to 11D are views showing an example of a device registration screen according to the present invention;

FIG. 12 is a view showing another example of the device registration screen according to the present invention; and

FIG. 13 is a view showing a further example of the device registration screen according to the present invention.

### DESCRIPTION OF THE EMBODIMENTS

Preferred embodiments of the present invention will be described below with reference to the drawings. However, note that dimensions, materials, shapes, relative arrangements, and so on of constituent components described below are to be modified appropriately in accordance with the configuration of the apparatus to which the invention is applied and various conditions, and the scope of the invention is not limited to the following description.

### First Embodiment

An outline of the present invention will be described below using the drawings.

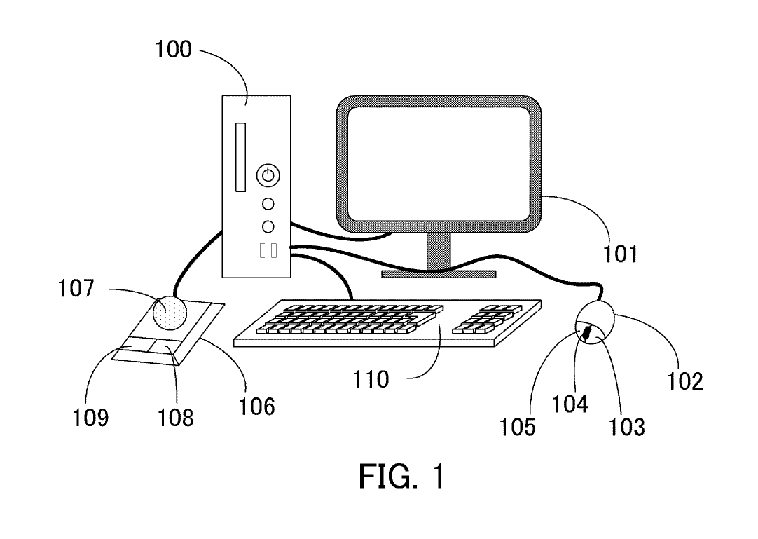

FIG. 1 shows a configuration of an apparatus according to the present invention. In FIG. 1, a reference numeral 100 denotes a computer that executes an application program according to the present invention. A reference numeral 101 denotes a display that displays a window of the application.

A reference numeral 102 denotes a mouse serving as one of pointing devices according to the present invention, with which a user inputs an operation instruction. A reference numeral 103 denotes a left side button attached to the mouse 102, which is used to select an object located in a position indicated by a mouse cursor, not shown in the drawing, displayed on the display 101, and so on. A reference numeral 104 denotes a rotatable wheel, which is effective when issuing an operation instruction corresponding to a rotation amount. The wheel 104 may be used in an image display application, for example, to scroll in a vertical direction, modify a display magnification, and so on. A reference numeral 105 denotes a right side button attached to the mouse 102, which is used to display a usable menu or the like in a position indicated by the aforesaid cursor.

A reference numeral 106 denotes a trackball serving as a pointing device with which the position of the mouse cursor can be moved by rotating a ball 107 similarly to the manner in which the position of the mouse cursor is moved by moving the mouse 102. A reference numeral 108 denotes a left side button attached to the trackball 106, which has similar functions to the left side button 103. A reference numeral 109 denotes a right side button having similar functions to the right side button 105. A reference numeral 110 denotes a keyboard used to input alphanumeric characters. Note that the left and right side buttons on the mouse and the trackball are set on the left and right sides when seen from the viewpoint of the user gripping the mouse.

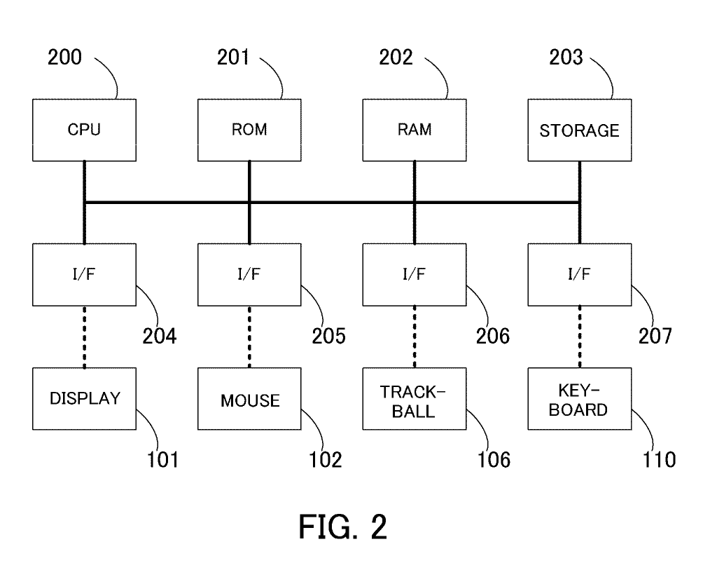

FIG. 2 shows an internal configuration of the computer 100 that executes the application program according to the present invention, and relationships thereof with various devices. A reference numeral 200 denotes a CPU that performs calculations required for processing. A reference numeral 201 denotes a ROM from which programs and data stored therein can be read. A reference numeral 202 denotes a RAM to and from which programs and data required for processing can be written and read. A reference numeral 203 denotes storage constituted by an HDD, an SSD, or the like, to and from which programs, image data, and so on can be written and read. Reference numerals 204 to 207 denote interfaces connected respectively to the display 101, the mouse 102, the trackball 106, and the keyboard 110. The CPU 200, or a combination of elements required to operate the CPU 200, or the entire computer 100, functions as an information processing apparatus that executes the application program according to the present invention.

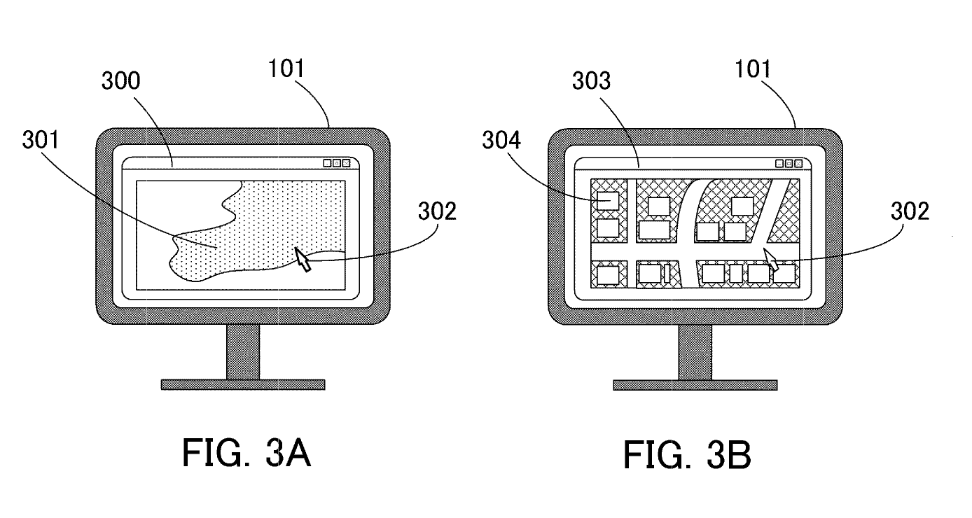

Next, using FIG. 3, an example of an application of the application program according to the present invention will be described. FIG. 3A shows an example of an application program for displaying a medical image, an application window 300 of which is displayed on the display 101. A medical image 301 is displayed in the application window 300. Examples of medical images include an x-ray image, a CT image, an MRI image, and so on. However, a pathological diagnosis image captured by enlarging a preparation using a high power lens may be cited as a more preferable example.

In the case of an image such as a pathological diagnosis image, in which it is necessary to observe both the entire subject preparation and an enlarged detailed portion, the image must be scrolled and the display magnification thereof must be modified during observation. When the display magnification is too low, the detailed portion cannot be observed, and therefore, to obtain a favorable diagnosis, the display magnification must be set at least at a predetermined value. When the image is larger than the application window at this predetermined display magnification, a partial image, i.e. a part of the overall image, is displayed in the window, and a display position of the image (a cropped partial image) is modified by performing a scroll operation.

Further, operations may be performed to add marks or comments to a location of interest. A reference numeral 302 denotes a cursor used to specify a position on the display 101. The cursor 302 is moved by issuing a movement instruction using a pointing device, for example by moving the mouse 102 or rotating the ball 107 of the trackball 106.

FIG. 3B shows an example of an application program for displaying a map, an application window 303 of which is displayed on the display 101. A map image 304 including roads and buildings displayed in the application window 303. The map is viewed to determine a route from a predetermined location to a destination and so on, for example, and when a distance between two points is large, the map must be viewed while scrolling the image. Furthermore, display magnification modification operations such as zooming out to search for an approximate route and, if necessary, partially zooming in to check a particular road may be performed. Moreover, in recent years, map application programs having an automatic route search function are available, and therefore operations to specify a start point and a destination of a route and so on may also be performed.

When an image that does not fit onto a single screen is displayed, as shown in FIGS. 3A and 3B, operations such as scrolling, modifying the display magnification, and specifying a position within the image may be performed. In a typical computer, the mouse 102 and the keyboard 110 are used as operation instruction input means. Operations to specify a predetermined position within the image in order to add a mark or specify a location on a map can be performed particularly easily using the mouse 102. Further, an operation to change a one-dimensional scale, such as a display magnification modification operation, can be performed easily using the wheel 104 that is limited to one-dimensional movement. However, it is well known that typically, an operation to scroll a large image or the like can be performed more easily using the trackball 106, which is capable of moving freely in a two-dimensional direction, than the mouse 102.

Here, the mouse 102 and the trackball 106 are sold in various shapes by various manufacturers, and preferred products differ among users. However, when a special device or driver is required, as in Japanese Patent Application Laid-open No. 2001-265532, it is difficult to allocate devices to respective functions, as described above, if the devices and drivers are not compatible therewith.

The present invention makes it possible to use an optimum operation instruction device for each function of an application program without using special devices and drivers.

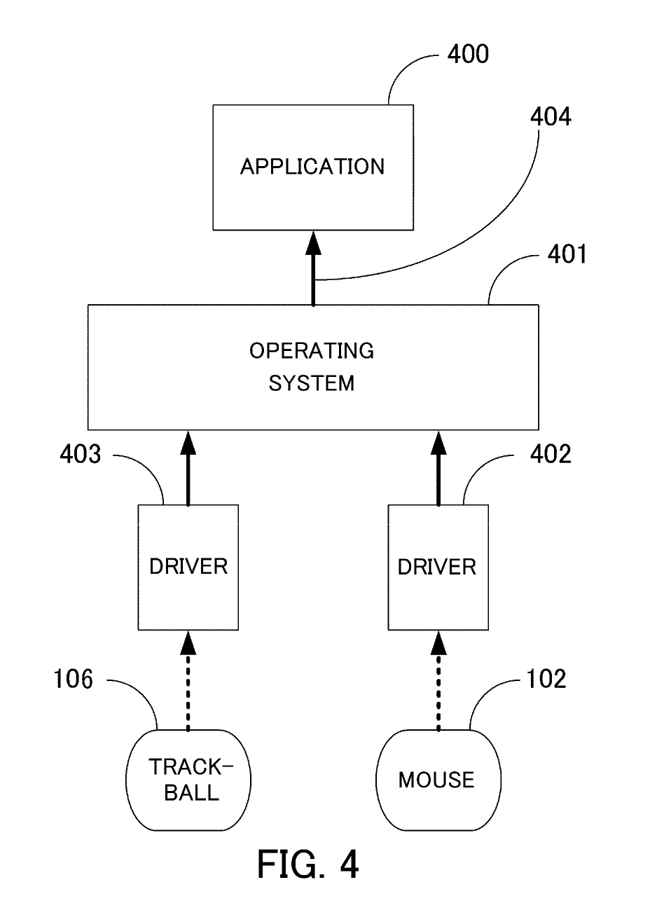

FIG. 4 is a view showing an operation instruction transmission path according to this embodiment. A reference numeral 400 denotes an application program serving as software that is operated under the management of an operating system (OS) 401. A reference numeral 402 denotes a driver that receives input from the mouse 102 and transmits operation instruction content to the OS 401. A reference numeral 403 denotes a driver that receives input from the trackball 106 and transmits operation instruction content to the OS 401. The operation instructions input from the drivers 402, 403 are transmitted to the application program 400 via the OS 401.

Here, a standard operation instruction command issued in relation to the mouse cursor 302 using a pointing device is defined as an operation instruction command generalized by the OS 401. Accordingly, information transmitted to the application program 400 from the OS 401 is transmitted as a generalized operation instruction command 404 without distinguishing between the mouse 102 and the trackball 106 serving as operation input devices, or between the drivers 402, 403. A message may be cited as a representative example of the generalized operation instruction command 404, and examples of messages include a message indicating that the mouse 102 has been moved, a message indicating that the left side button 103 has been pressed, and so on.

Further, the application program 400 is normally created independently of the pointing devices so that the application program 400 does not recognize the device from which the operation instruction is input. However, in the application program according to the present invention, the device is specified via the OS 401. In the application program 400, therefore, an operation of the application program 400 can be determined in consideration of both the operation instruction command 404 and information indicating the device from which the operation instruction corresponding to the operation instruction command 404 is input. As a result, an optimum device can be allocated to each function of the application program 400 using a plurality of general-purpose pointing devices.

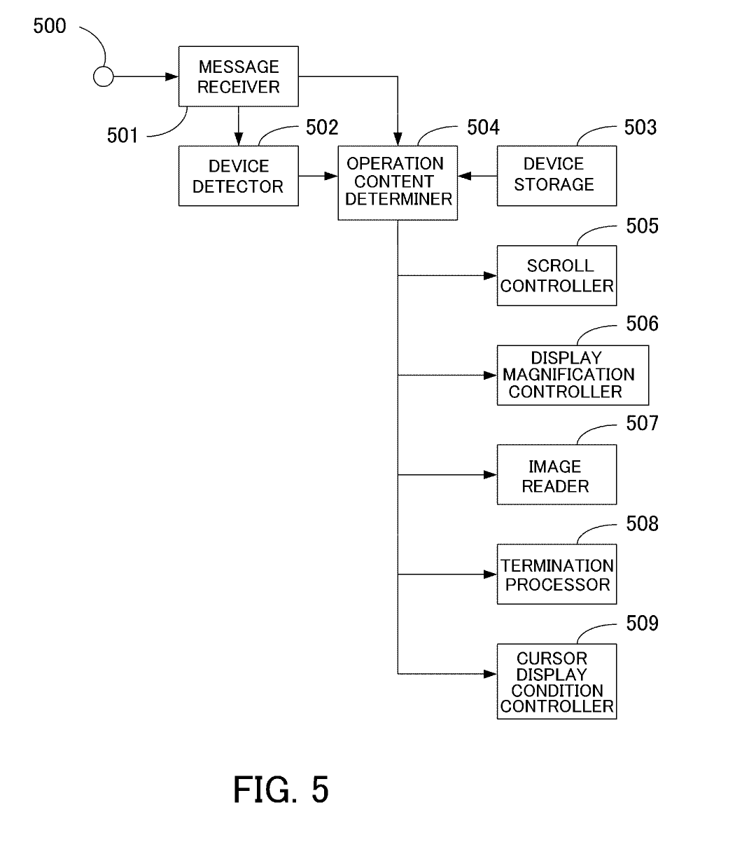

FIG. 5 is a view showing function blocks of the application program 400 according to this embodiment. A reference numeral 500 denotes an input terminal from which a message indicating an operation instruction command transmitted from the OS 401 is input. Note that the message input from the input terminal 500 is not limited to an operation instruction from a pointing device, as described above. For example, the message may be a message indicating selection of an application menu or any other message that must be relayed to the application program 400.

A reference 501 denotes a message receiver including a message queue in which received messages are accumulated, determination means for determining whether or not a message has arrived, and so on. A reference numeral 502 denotes a device detector that detects identification information indicating the device corresponding to the received message. A reference numeral 503 denotes a device storage that stores the identification information of the corresponding device in association with each function of the application program 400. Note that preset identification information is stored in the device storage 503. Further, the device storage 503 does not have to store identification information in association with all functions, and may store information relating only to a function to be associated with an operation performed by a specific device.

A reference numeral 504 denotes an operation content determiner that determines operation content of the application program 400 on the basis of the received message, the identification information detected by the device detector 502, and the identification information stored in the device storage 503. A reference numeral 505 denotes a scroll controller that executes a scroll operation when the operation content determiner 504 determines that an operation to scroll the displayed image has been issued. A reference numeral 506 denotes a display magnification controller that executes an operation to modify the display magnification when the operation content determiner 504 determines that an instruction to modify the display magnification has been issued.

A reference numeral 507 denotes an image reader that reads and displays a specified image when the operation content determiner 504 determines that an instruction to display a new image has been issued. A reference numeral 508 denotes a termination processor that terminates the application program 400 when the operation content determiner 504 determines that an instruction to terminate the application program 400 has been issued. A reference numeral 509 denotes a cursor display condition controller that controls display of the cursor in accordance with the content determined by the operation content determiner 504.

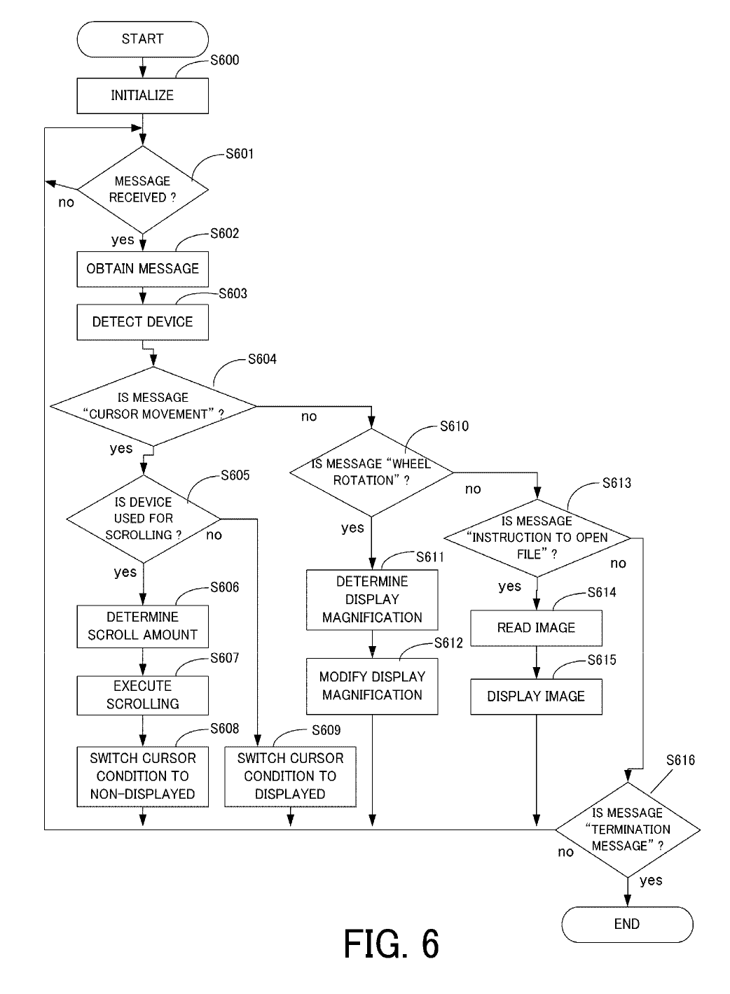

FIG. 6 is a flowchart showing an operation flow of the application program 400 according to this embodiment. When processing begins, first, in step 600, initialization processing is performed on the application program in order to display the application window. In step 601, a determination is made as to whether or not a message indicating an operation instruction command has been received. When it is determined that a message has not been received, the processing returns to step 601 to wait for a message to be received. When it is determined in step 601 that a message has been received, the processing advances to step 602, where the received message is obtained from the message queue. In step 603, the identification information of the device corresponding to the message is detected.

In step 604, the content of the message is determined, and when the content indicates cursor movement, the processing advances to step 605. In step 605, a determination is made as to whether or not the identification information of the used device matches the identification information of a device used for scrolling. When a match is determined in step 605, a scroll amount is determined in step 606, whereupon scrolling is executed in step 607. In step 608, the cursor is set in a non-displayed condition, whereupon the processing returns to step 601 to wait for a message to be received.

When it is determined in step 605 that the identification information does not match the identification information of the device used for scrolling, it is determined that a normal mouse cursor movement instruction has been issued. The cursor is then set in a displayed condition in step 609, whereupon the processing returns to step 601 in order to wait for a message to be received.

When, in step 604, the message content is not content indicating cursor movement, on the other hand, the processing advances to step 610, where a determination is made as to whether or not the message content is content indicating wheel rotation. When, in step 610, the message content is content indicating wheel rotation, the processing advances to step 611, where the display magnification is determined on the basis of a rotation amount and a rotation direction of the wheel. The display magnification is then modified in step 612, whereupon the processing returns to step 601 in order to wait for a message to be received.

When, in step 610, the message content is not content indicating wheel rotation, the processing advances to step 613, where a determination is made as to whether or not the message content is content for opening a file. When, in step 613, the message content is content for opening a file, the processing advances to step 614, where a specified image file is read, or in other words image input is performed. The read image is then displayed in step 615, whereupon the processing returns to step 601 in order to wait for a message to be received.

When, in step 613, the message content is not content for opening a file, the processing advances to step 616, where a determination is made as to whether or not the message content is content indicating termination of the application program. When, in step 616, the message content is content indicating termination of the application program, the application program is terminated. When the message content is not content indicating termination of the application program, on the other hand, the processing returns to step 601 to wait for a message to be received.

Note that in the flow shown in FIG. 6, the device detection processing of step 603 may be performed only when required following steps 604, 605, 610, 613, and so on, i.e. the processing for determining the message content.

Further, in the flow of FIG. 6, when the message content is content indicating wheel rotation in step 610 or the message content is content for opening a file in step 613, the cursor condition is not modified. This means that the current cursor display condition is maintained. Maintenance of the current cursor condition is included in the content of the cursor display control performed by the cursor display condition controller 509. Note that the present invention is not limited to the flow shown in FIG. 6, and the order in which the operation content processing and the cursor display condition control processing are performed may be switched. Furthermore, when the message content is content indicating wheel rotation in step 610 or the message content is content for opening a file, the cursor display condition may be set in a specific condition.

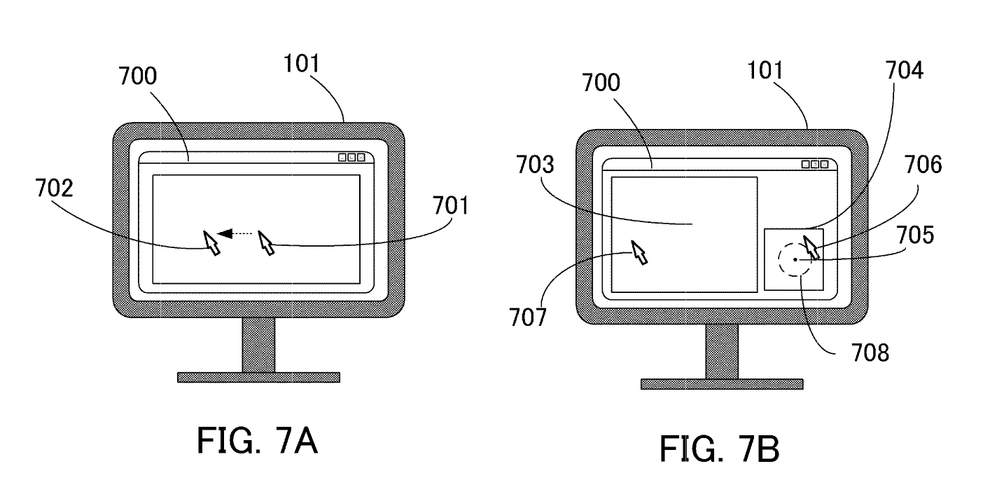

FIG. 7 is a view showing an example of a scroll method and a method of determining a scroll movement amount, employed in step 606.

In FIG. 7A, a reference numeral 700 denotes an application window. 701 denotes a cursor that has been moved in order to specify a predetermined position within the application window 700 (for example, a position from which the cursor can be moved in all directions, such as the center of the window), and indicates a reference position used to determine the scroll movement amount. A reference numeral 702 denotes the cursor after being moved in response to a mouse movement instruction from the device used for scrolling. When a message indicating a mouse movement instruction is received, a movement amount (X, Y direction) is determined by comparing the cursor positions 701 and 702 and a movement direction. Furthermore, by moving the cursor 702 to the cursor position 701 forcibly after determining the movement amount, the cursor is prevented from moving to an end portion of the screen so as to become unable to move any further in the same direction.

Note that when a mouse movement instruction from the device not used for scrolling is switched to a mouse movement instruction from the device used for scrolling, the cursor position is stored and the cursor is not displayed. Conversely, when a mouse movement instruction from the device used for scrolling is switched to a mouse movement instruction from the device not used for scrolling, the cursor is preferably moved to the stored cursor position and set in the display condition. In so doing, repeated meaningless movements of the cursor over the screen are not displayed, and therefore an image can be displayed such that viewing of the image is not impaired.

FIG. 7B is a view showing another example of the method of determining the scroll amount in step 606. In FIG. 7B, a scroll control region 704 is provided in addition to an image display region 703. A reference numeral 705 denotes a reference position. The movement amount (X, Y direction) is determined from the position and direction of the reference position 705 relative to a cursor position 706. Here, when the operation instruction switches to a mouse movement instruction from the device not used for scrolling, the cursor position is stored and then moved forcibly to the cursor position 707 within the image display region 703. When the operation instruction is switched to a mouse movement instruction from the device used for scrolling, on the other hand, the cursor position is stored and then moved forcibly to 706.

Note that when the operation instruction is switched to a mouse movement instruction from the device not used for scrolling, the cursor position 706 may be moved to the position 705 on the assumption that the scroll operation has stopped. Further, a dead region 708 centering on 705 is preferably provided in the scroll control region. By ensuring that the cursor is not moved when the cursor exists in the region 708, scrolling can be stopped easily.

The movement amount may be set to be proportionate to a relative distance between the reference position and the cursor position. However, the cursor may be moved unintentionally by small movements of the hand. In this case, when the movement amount is simply proportionate to the distance, unevenness may occur in a movement speed and the movement direction, and as a result, it may be difficult to observe the image.

Therefore, a predetermined, fixed movement amount may be set. For example, the movement speed may be set at a single fixed value, and the movement direction may be limited to vertical and horizontal directions or the like. Further, a plurality of fixed values may be set, and the applied fixed value may be switched when the relative distance between the reference position and the cursor position exceeds a predetermined threshold or the like. For example, when the relative cursor position is removed by at least a predetermined value, unevenness is more likely to occur in the scrolling movement due to high speed hand movements, and therefore the movement speed is set at a fixed speed and the movement direction is limited to eight vertical, horizontal, and diagonal directions. Conversely, when the relative cursor position is not removed by at least the predetermined value, the movement amount may be set to be proportionate to the relative distance between the reference position and the cursor position in order to perform fine operations in a sensory manner using low speed hand movements.

In the embodiment described above, a message indicating cursor movement is determined when performing a scroll operation, but the present invention is not limited thereto. For example, when the trackball is used, a rotation amount of the ball must be detected. Accordingly, the cursor position may be obtained at predetermined time intervals using a periodic timer, and a difference between the obtained cursor position and a position obtained during a previous period may be determined as the movement amount. The scroll direction and the scroll amount may then be determined on the basis of the movement amount.

In this case, as described in relation to FIG. 7A, the cursor is preferably moved forcibly to the cursor position 701 after detecting the movement amount to prevent a situation in which scrolling cannot be performed at the end portion of the display. Further, when the cursor is moved forcibly to 701, as described above, the cursor may move rapidly and repeatedly in the vicinity of 701, thereby obstructing observation of the display content. In this case, therefore, the cursor is preferably not displayed.

Hence, according to the present invention, the cursor position may be obtained (detected) and reflected in the scroll operation on the basis of a different trigger from which cursor movement can be detected instead of the message indicating cursor movement.

Note that the present invention is not limited to the embodiment described above, and the device may be determined likewise when the message content indicates an operation other than cursor movement. For example, in a case where the two pointing devices are both capable of performing typical wheel operations, the device may be determined when the message indicates wheel rotation. In a preferred example of this case, Z-stack images, which are constituted by a plurality of captured pathological diagnosis images of the type described above arranged in a depth direction, are displayed. In this case, the display magnification is preferably modified using one of the pointing devices, and a depth direction position is preferably switched using the other pointing device.

Furthermore, the present invention may be applied to a menu operation such as opening a file. For example, in the case of the pathological diagnosis image described above, a plurality of images may be displayed side by side and compared, or a single image may be displayed. In a preferred example of an operation performed to open a file while a single image is already displayed, when one pointing device is used, the displayed image is closed and a single, newly specified image is displayed, and when the other pointing device is used, the display region is divided and the newly specified image is displayed side by side with the displayed image.

The application subject of the present invention is not limited to a menu operation, and the present invention may be applied to various subjects that are unique to the application 400, such as buttons and list displays. For example, operation content corresponding to a button may be switched in accordance with the used pointing device, or a list of selectable items in a combo box may be switched in accordance with the used pointing device. With the OS 401 and the driver 402, it is difficult to switch operation instructions issued in relation to subjects that are unique to the application, such as menu operations and buttons, in accordance with the pointing device. When conversion software is interposed between the application 400 and the OS 401, it is similarly difficult to switch operation instructions issued in relation to subjects that are unique to the application in accordance with the pointing device. In other words, the present invention makes it possible to switch operation instructions issued in relation to subjects that are unique to the application in accordance with the pointing device.

Furthermore, special operations are not limited to a case in which the trackball 160 is used, and an operation such as adding marks and comments to the image may be performed only when the used device is the mouse 102, for example. In this case, by moving the mouse 102, the mouse cursor 302 is moved over the screen to a position in which a mark or a comment is to be inserted. An operation such as inserting a comment, a character string, or the like is then performed using the left side button 103, the right side button 105, or the keyboard 110. The devices may thus be allocated appropriately in accordance with the functions.

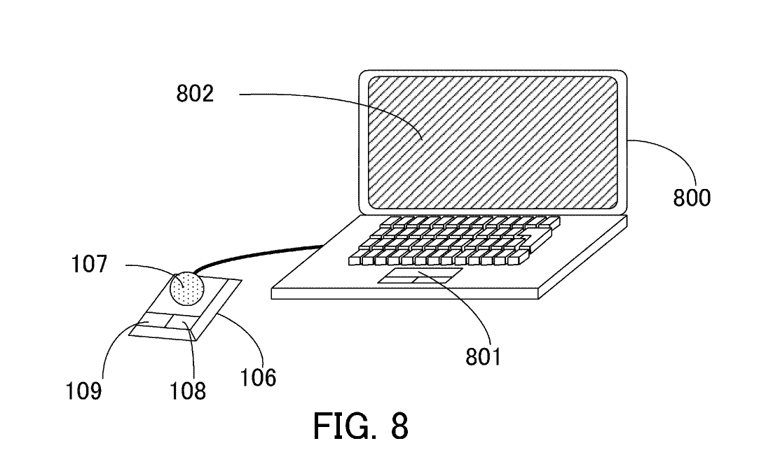

Furthermore, in the above description, the mouse and the trackball are cited as pointing devices, but the present invention is not limited thereto. FIG. 8 shows an example of another pointing device to which the present invention may be applied. 800 denotes a laptop PC. 801 denotes a touchpad serving as a pointing device for use with the portable laptop PC, with which cursor movement and click instructions can be issued even when an external device such as a mouse is absent. The touchpad 801 serves as the application subject of the present invention.

Moreover, a touch panel 802 may be installed in a display of the laptop PC 800 so that a position on a screen is specified directly by touching the screen with a finger or the like. A position can be specified with the touch panel 802 in a similar manner to the mouse and so on, and a specified position on the screen may be considered as the current cursor position. Hence, the touch panel 802 constitutes the pointing device serving as the application subject of the present invention.

Similarly to the above description, an example in which the trackball 106 is allocated to scrolling and the touchpad 801 or the touch panel 802 is allocated to another operation, for example, may be considered. Note that in FIG. 8, a laptop PC is envisaged, but the present invention is not limited thereto, and a touch panel may also be installed in the display 101 of a desktop PC. Furthermore, tablet type terminals not including a keyboard, on which normal operations are performed using a touch panel on a screen, have increased in popularity recently. A pointing device may be connected to a tablet type terminal, and the present invention may be applied to a combination of the pointing device and the touch panel installed in the tablet type terminal.

In the above example, described using FIG. 7A, the display condition of the cursor is switched between a non-displayed condition and a displayed condition in accordance with whether or not scrolling is performed. However, this control is not limited to scrolling, and whether or not to display the cursor may be determined in consideration of the need to display the cursor in the selected function. In the above example, there is no need to display the cursor when scrolling the displayed image, and when displayed, the cursor in fact obstructs observation of the image. With this type of function, the cursor is preferably set in the non-displayed condition. Further, in the case of a function such as adding a comment or a mark to the image, in which it is necessary to specify a position, the cursor must be displayed, and therefore the cursor is preferably set in the displayed condition. Moreover, when the cursor is not required, instead of not displaying the cursor at all, the cursor may be made less visible by making the cursor opaque, reducing the size of the cursor, changing the color of the cursor to a color closer to a background color, and so on.

Furthermore, when the cursor is not required in FIG. 7A, the cursor may be made less likely to obstruct observation of the image by, for example, setting 701 in a position other than the vicinity of the center position of the window and displaying the cursor in that position. As shown in FIGS. 7A and 7B, the cursor display condition according to the present invention includes various display conditions such as the color, transparency, size, and position of the cursor. In other words, the cursor display condition includes any element by which the visibility of the cursor on the displayed image can be modified.

An example in which only general-purpose pointing devices and drivers are used was described above as a preferred example of the present invention. However, in a case where a combination of a special pointing device and driver and a general-purpose pointing device is used, the method described above may be applied to a specific general-purpose pointing device. A device such as a game controller, in which a large number of buttons is provided and corresponding operation instruction content is allocated by driver setting, may be cited as an example of a special device that is combined with a general-purpose device.

The processing for switching the used device is not limited to the content described above, and may be performed in response to input of various other operation instructions. The executed operation content is likewise not limited to the content described above. Further, the plurality of devices may be connected using a desired method other than a USB connection method or a method of installing the devices in the computer, as described above. Moreover, the devices may be connected either wirelessly or with a wire.

According to this embodiment, described above, an optimum device can be allocated to each function of an application program using a plurality of general-purpose pointing devices. For example, wide-range image display can be realized easily such that both wide-range scroll processing, which is required to move the cursor by a great distance, and accurate pointing processing are possible. Moreover, the present invention can be realized using application program functions and typical messages, and therefore limitations on the operating system, the drivers, middleware, and so on can be reduced, and any desired devices can be used.

### Second Embodiment

In the first embodiment, a method of operating different functions of an application using a plurality of pointing devices was described. In this embodiment, a method of registering the functions in association with the plurality of pointing devices will be described.

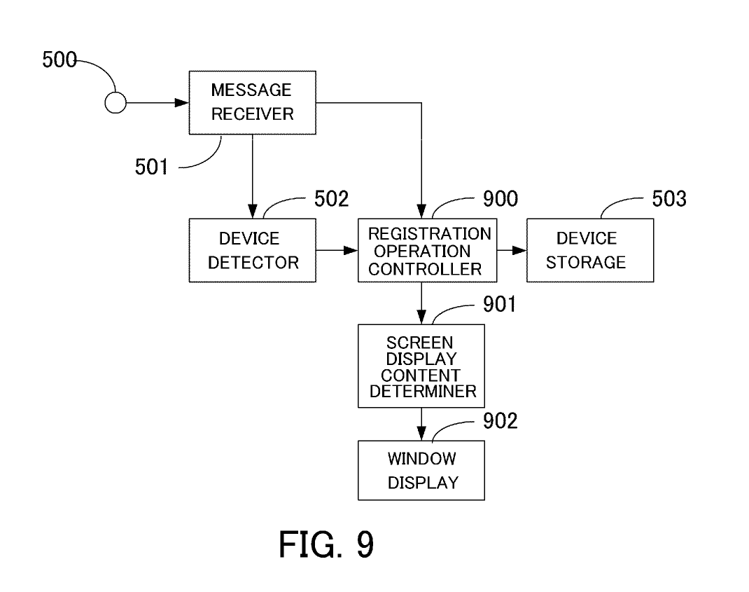

FIG. 9 is a view showing a part of the function blocks of the application program 400 according to this embodiment. FIG. 9 shows a configuration of a register for registering a used pointing device. Note that identical items to those shown in FIG. 5 have been allocated identical reference numerals, and description thereof has been omitted.

A reference 900 denotes a registration operation controller that performs operations to determine a function in association with which a device is to be registered, and store the identification information of the device, input from the device detector 502, in the device storage 503 in association with the function. A reference numeral 901 denotes a screen display content determiner that determines screen display content on the basis of information indicating a function for which registration is to be performed on a current screen, input from the registration operation controller 900. A reference numeral 902 denotes a window display that displays a window on the basis of the screen display content determined by the screen display content determiner 901.

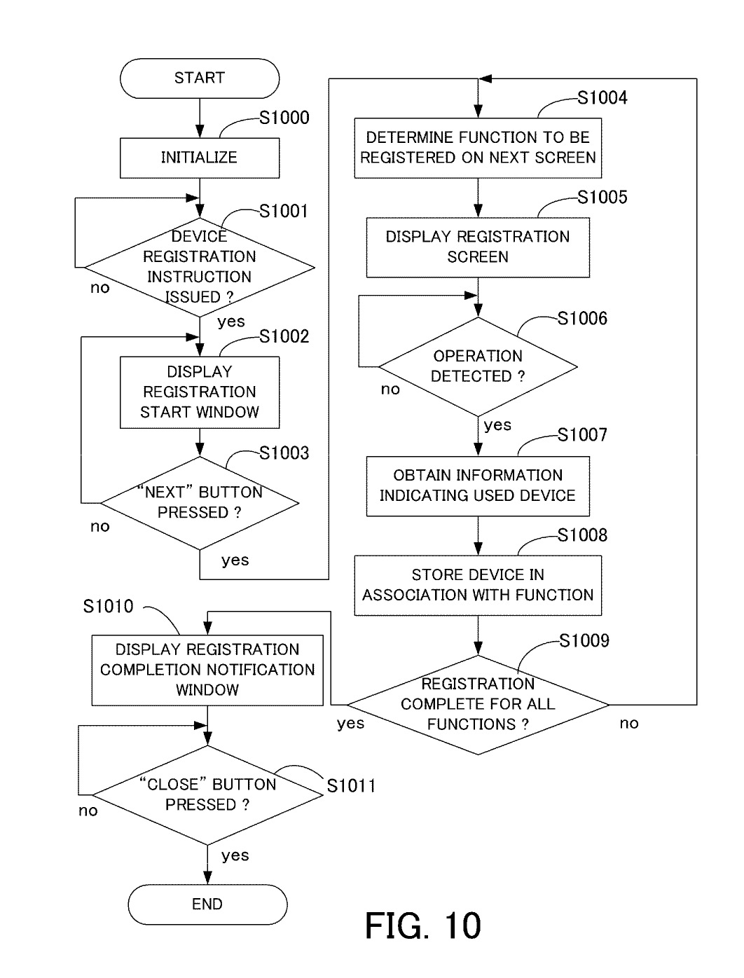

FIG. 10 is a flowchart showing an operation flow of the application program 400 according to this embodiment. FIG. 10 shows a flow of processing performed to register the used pointing device. The registration processing may be started automatically during an initial operation of the application program, or a function for receiving a start instruction at any time may be provided. Alternatively, the processing may be started at any time as required, for example when a new pointing device is connected.

When the processing starts, first, in step 1000, initialization of the registration processing is performed. Next, in step 1001, the processing waits for an instruction to start device registration to be issued. When an instruction to start device registration is issued in step 1001, a start window informing the user that registration is about to begin is displayed in step 1002. In step 1003, the processing waits for a button, described below, to be pressed as an operation instruction for displaying the next screen on the start window, and when the button is pressed, the processing advances to step 1004.

In step 1004, the function to be registered is determined on the next screen, whereupon a registration screen is displayed in step 1005 on the basis of information indicating the determined function. In step 1006, the processing waits for an operation instruction to be input from a pointing device on the registration screen, and when the operation instruction is input, the processing advances to step 1007. In step 1007, the identification information of the pointing device used to input the operation instruction on the registration screen is obtained, and in step 1008, the identification information of the device is stored in association with the function. In step 1009, a determination is made as to whether or not registration is complete in relation to all functions to be registered, and when an unregistered function exists, the processing returns to step 1004 to perform the registration processing on the next function. When it is determined in step 1009 that all functions have been registered, on the other hand, the processing advances to step 1010.

In step 1010, a completion window informing the user that the registration processing is complete is displayed. In step 1011, the processing waits for a button used to close the completion window to be pressed, and when the button is pressed, the processing is terminated.

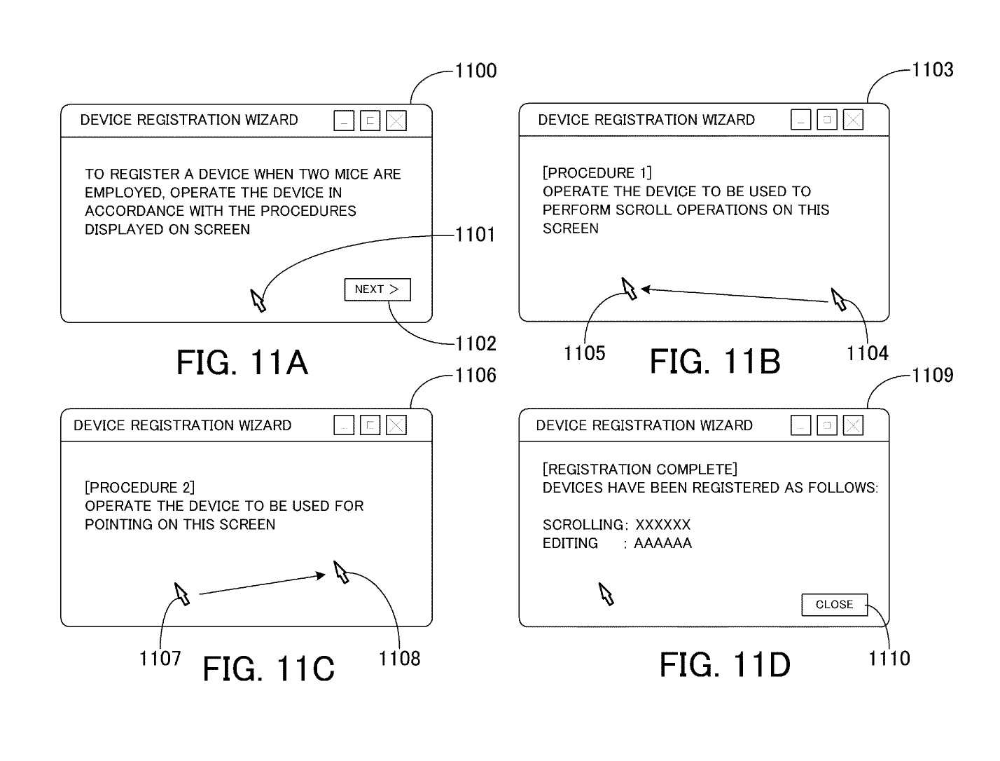

Next, using FIG. 11, examples of display screens and an example of a registration method according to this embodiment will be described. In FIG. 11A, a reference numeral 1100 denotes the device registration start window, which is displayed to inform the user of the registration method, operation procedures, and so on. A reference numeral 1101 denotes a cursor. The user inputs operation instructions to move the position of the cursor, click the cursor position, and so on by operating a general-purpose pointing device. A reference numeral 1102 denotes the button used to terminate display of the start window and shift to the next display.

When the button 1102 is pressed using the cursor 1101, the registration window is displayed, as shown in FIG. 11B. In the example of FIG. 11B, a reference numeral 1103 denotes a window for registering the device used to perform a scroll operation. By moving cursors 1104 and 1105 over the window 1103 using the pointing device to be used to perform a scroll operation, an operation instruction command is transmitted to the application program 400 via the OS. The application program 400, having received the operation instruction command, obtains the information of the used device, and stores the device in association with the scroll operation in accordance with the flow shown in FIG. 10, described above.

When the corresponding device has been registered on the registration window shown in FIG. 11B, a display shown in FIG. 11C is displayed. In the example of FIG. 11C, a reference numeral 1106 denotes a window for registering a device to be used to perform a pointing operation required to specify a position in which to insert alphanumeric characters, symbols, or the like. Likewise in FIG. 11C, by moving cursors 1107 and 1108 over the window 1106 using the pointing device to be used to perform the pointing operation, the device is stored in association with the pointing operation.

When the corresponding device has been registered on the registration window shown in FIG. 11C, a completion window 1109 shown in FIG. 11D is displayed. The completion window 1109 shows whether or not registration has been completed normally, and displays associations between the functions and the devices as registration content. When a button 1110 is pressed, the completion window 1109 is closed, and the processing is terminated.

Note that the registration start window 1100 and the completion window 1109 do not have to be displayed, and may be displayed as required, or displayed within the registration windows 1103, 1106, and so on.

The display content in the windows 1100, 1103, 1106, 1109 shown in FIG. 11 may be switched within a single window. Alternatively, the respective windows may be created individually and closed when the next screen is displayed.

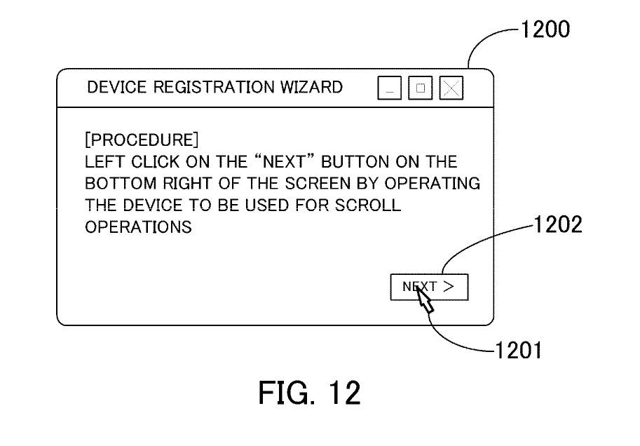

Here, an example in which device registration is performed in response to a cursor movement instruction on the registration windows shown in FIGS. 11B and 11C was described, but the present invention is not limited thereto. For example, FIG. 12 shows another example of a registration window. A registration window 1200 is provided with a button 1202 for receiving an input instruction to advance to the next procedure. When the button 1202 is pressed using a cursor 1201, registration is performed in accordance with a button depression notification transmitted to the application program 400. Needless to mention, instead of providing the button 1202 in FIG. 12, a click operation performed in any location within the registration window 1200 may be detected.

Furthermore, on the registration windows shown in FIGS. 11B and 11C and FIG. 12, a single operation instruction device is stored in relation to a single registration subject function on the registration screen. However, the present invention is not limited thereto.

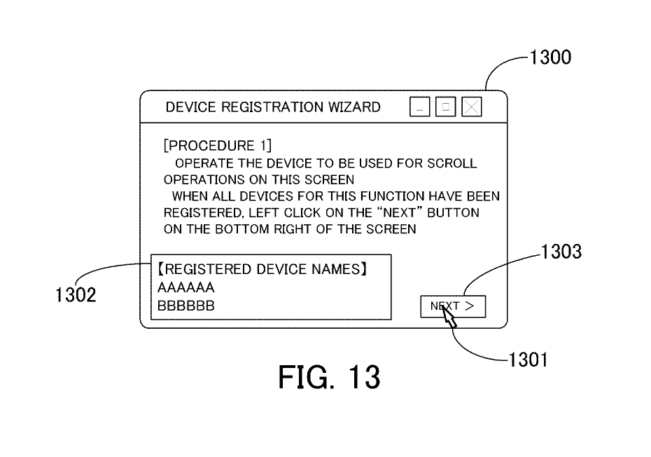

FIG. 13 shows an example of a registration window on which a plurality of operation instruction devices can be registered in relation to a single function. A registration window 1300 is provided with a registered device name display region 1302 in which a plurality of registered device names can be displayed, and a button 1303 for receiving an input instruction to advance to the next procedure. By moving a mouse cursor 1301 over the registration window 1300 or performing a click operation within the registration window 1300, all devices that have issued operation instructions are registered, and the device names thereof are displayed in the registered device name display region 1302. When the button 1303 is pressed after operations have been performed using all of the devices to be registered, the registration window 1300 is closed, thereby terminating the registration processing in relation to the subject function, and the next screen is displayed.

When devices are registered in association with a function using the method described in this embodiment, depending on the registration content, a defect may occur during execution of an operation. For example, when a single device is registered in association with a plurality of functions, the single device may be allocated to both the scroll operation and the pointing operation. When this type of registration is permitted and the registered device is moved, the cursor may move while scrolling is underway, and as a result, it may be difficult to perform a cursor operation in a desired position. Therefore, a combination of functions for which a single device cannot be registered is preferably stored in advance as an exclusion function. When an attempt is made to register a single device in association with the exclusion function, processing such as issuing a warning display or not executing the registration processing in relation to the device is performed. As a result, prohibited registration can be suppressed.

Note that the device registration method according to this embodiment is described as being executed in the application program 400 according to the first embodiment. However, the present invention is not limited thereto, and the device registration method may be executed in a different application program for registering a file, a registry, or the like storing the devices used by the application program 400, for example. A case in which an executable file with a different executable form of the application is practically used in combination is included within the scope of application of the present invention.

According to this embodiment, described above, an optimum device can be allocated to each function of an application program using a plurality of general-purpose pointing devices.

### OTHER EMBODIMENTS

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-041765, filed on Mar. 4, 2014, and Japanese Patent Application No. 2014-041766, filed on Mar. 4, 2014, which are hereby incorporated by reference wherein in their entirety.

What is claimed is:

1. A non-transitory computer readable medium storing an application program causing a computer to execute a method comprising steps of:
inputting an operation instruction using a plurality of pointing devices;
detecting information indicating a used pointing device on the basis of the operation instruction;
determining operation content on the basis of the operation instruction from at least one of the plurality of pointing devices; and
storing information indicating the pointing device corresponding to the operation content,
wherein, in the operation content determining step, the operation content is determined on the basis of the operation instruction, the information indicating the pointing device detected in the device detecting step, and the information indicating the pointing device stored in the device storing step.

2. The non-transitory computer readable medium according to claim 1, wherein the application program further causes the computer to execute steps of:
inputting an image; and
displaying at least part of the image, and
the operation content determined in the operation content determining step includes at least operation content relating to image display.

3. The non-transitory computer readable medium according to claim 2, wherein the application program further causes the computer to execute a step of performing scrolling to modify a display position of the image, and
the operation content determined in the operation content determining step is scrolling.

4. The non-transitory computer readable medium according to claim 3, wherein, in the displaying step, when the image is larger than an application window corresponding to the application program at least at a predetermined display magnification, a part of the image is displayed on a display in the application window, and
in the scrolling step, the display position of the image displayed in the application window is modified.

5. The non-transitory computer readable medium according to claim 3, wherein the operation instruction is an operation instruction relating to movement of a cursor, and
in the scrolling step, at least one of a scrolling method and a scrolling amount is determined on the basis of the operation instruction relating to movement of the cursor.

6. The non-transitory computer readable medium according to claim 5, wherein the operation instruction relating to movement of the cursor is a message transmitted from an operating system of the computer to the application program.

7. The non-transitory computer readable medium according to claim 5, wherein the application program further causes the computer to execute a step of obtaining a current cursor position at predetermined time intervals, and
the operation instruction is determined on the basis of the cursor position obtained at a plurality of time intervals.

8. The non-transitory computer readable medium according to claim 1, wherein the application program further causes the computer to execute a step of controlling a display condition of a cursor, and
in the operation content determining step, the operation content and the display condition of the cursor are determined on the basis of the operation instruction, the information indicating the pointing device detected in the device detecting step, and the information indicating the pointing device stored in the device storing step.

9. A non-transitory computer readable medium storing an application program causing a computer to execute a method comprising steps of:
inputting a general-purpose operation instruction of an operating system as an operation instruction transmitted from a pointing device;
detecting information indicating the used pointing device on the basis of the operation instruction;
determining operation content on the basis of the operation instruction; and
storing information indicating the pointing device corresponding to the operation content,
wherein, in the operation content determining step, the operation content is determined on the basis of the operation instruction, the information indicating the pointing device detected in the device detecting step, and the information indicating the pointing device stored in the device storing step.

10. A non-transitory computer readable medium storing an application program causing a computer to execute a method comprising steps of:
inputting an operation instruction using a plurality of pointing devices;
detecting information indicating a used pointing device on the basis of the operation instruction;
determining operation content on the basis of an operation instruction from at least one of the plurality of pointing devices;
storing information indicating the pointing device corresponding to the operation content; and
displaying a registration window for setting the pointing device stored in the device storing step,
wherein, in the registration window displaying step, the registration window is displayed for each operation content in relation to which the information indicating the pointing device is stored,
in the device detecting step, information indicating the pointing device that issues the operation instruction to the registration window is detected, and
in the device storing step, information indicating the pointing device detected in the device detecting step is stored.

11. The non-transitory computer readable medium according to claim 10, wherein the application program further causes the computer to execute steps of:
inputting an image; and
displaying at least part of the image, and
the operation content determined in the operation content determining step includes at least operation content relating to image display.

12. The non-transitory computer readable medium according to claim 11, wherein the application program further causes the computer to execute a step of performing scrolling to modify a display position of the image, and
the operation content determined in the operation content determining step is scrolling.

13. The non-transitory computer readable medium according to claim 10, wherein the operation instruction issued in relation to the registration window is an operation instruction relating to movement of a cursor.

14. The non-transitory computer readable medium according to claim 10, wherein the operation instruction issued in relation to the registration window is a click operation performed in a position included in the registration window.

15. The non-transitory computer readable medium according to claim 10, wherein the operation instruction issued in relation to the registration window is a click operation performed on a button included in the registration window.
